(19) United States
(12) Patent Application Publication
(10) Pub. No.: US 2016/0259820 A1
(43) Pub. Date: Sep. 8, 2016

(54) SYSTEMS AND METHODS FOR PROCESSING NON-SIMILAR DATA

(71) Applicant: CATERPILLAR INC., Peoria, IL (US)

(72) Inventors: Sanat Arun TALMAKI, Peoria, IL (US); Ryan BAUMANN, Peoria, IL (US); Christopher Michael SPROCK, East Peoria, IL (US)

(73) Assignee: CATERPILLAR INC., Peoria, IL (US)

(21) Appl. No.: 14/638,487

(22) Filed: Mar. 4, 2015

(51) Int. Cl. G06F 17/30

(52) U.S. Cl. CPC G06F 17/30345; G06F 17/30312

(57) ABSTRACT

Systems and methods are disclosed for collecting and processing non-similar data. According to certain embodiments, a first set of signals produced by a first set of sensors is received. The first set of signals is indicative of machine parameters. The machine parameters are organized by a plurality of data channels. Each of the plurality of data channels is associated with a distinct characteristic. A second set of signals produced by a second set of sensors is also received. The second set of signals is indicative of location information associated the machine and corresponding timestamps. The machine parameters, location information, and timestamps are received at a server. The machine parameters, location information, and timestamps are merged into a table. In the table, the machine parameters may be aggregated according to at least one of corresponding data channel, timestamp, and machine ID. A request from a user for information from the table is received. Then the information is output to the user.

### TECHNICAL FIELD

The present disclosure relates generally to systems and methods for processing non-similar data, and more particularly, to systems and methods for processing data of different characteristics or data from different sources.

### BACKGROUND

Heavy machines, such as bulldozers and track-type tractors, often form a fleet and operate at remote worksites. These machines can be equipped with sensors that generate data regarding performance and operation of the machines, the operators, and the worksites. The data provides value to users of the machines and the fleets. For example, the users can track the machine and prevent its theft based on the data. In another example, the users can determine whether a machine is functioning properly based on the data. Moreover, the ability to combine machine data with different characteristics or from different types of machines has become critical for users to understand the performance of the machines and fleets, and to better manage them. For example, a fleet manager can analyze which part of the worksite is damaging the fleet based on a combination of the machine locations and on-board operating parameters.

Conventionally, because the machine data with different characteristics or from different types of machines is collected and stored in disparate data sets, different methods must be performed separately to combine data of different varieties. This has been time-consuming and inefficient. Even more, with the improving abilities of machines to generate useful data, the volume of the available data has grown and has increased the burden of quickly combining data of different varieties.

One method of collecting and processing machine data of different varieties is described in U.S. Pat. No. 7,599,775 (the '775 patent) issued to Furuno on Oct. 6, 2009. The '775 patent describes an operational-information managing apparatus for a construction machine. The apparatus first collects and stores multiple kinds of operational data of a construction machine. Users of the apparatus determine what data among the stored operational data is top-priority operational data. The apparatus then extracts the top-priority operational data from the stored operational data, and transmits the extracted data to the users via satellite communication.

Although the apparatus of the '775 patent may offer a way to collect and process machine data of different varieties, it may still be less than optimal. In particular, because only the top-priority operational data is extracted and transmitted to the users, the users cannot readily use all the available machine data to analyze the performance of a machine or a fleet. Moreover, if the top-priority data itself contains a large variety of data, the data-processing time may be prolonged.

The disclosed system is directed to overcoming one or more of the problems set forth above.

### SUMMARY OF THE INVENTION

In one aspect, the present disclosure is directed to a method of collecting and processing machine data. The method includes receiving a first set of signals produced by a first set of sensors. The first set of signals is indicative of machine parameters. The machine parameters are organized by a plurality of data channels. Each of the plurality of data channels is associated with a distinct characteristic. The method also includes receiving a second set of signals produced by a second set of sensors. The second set of signals is indicative of location information associated with the machine and corresponding timestamps. The machine parameters, location information, and timestamps are received at a server. The server merges the machine parameters, location information, and timestamps into a table. Merging the machine parameters, location information, and timestamps into a table may include aggregating the machine parameters according to at least one of corresponding data channel, timestamp, and machine ID. The method further includes receiving a request from a user for information from the table and outputting the information to the user.

In another aspect, the present disclosure is directed to a non-transitory computer-readable storage medium storing instructions for collecting and processing machine data. The instructions cause the at least one processor to perform operations including receiving machine parameters organized by a plurality of data channels. Each of the plurality of data channels is associated with a distinct characteristic. The operations also include receiving location information associated with the machine and corresponding timestamps. The operations further include transferring the machine parameters, location information, and timestamps to a server. Moreover, the operations include merging the machine parameters, location information, and timestamps into a table. Merging the machine parameters, location information, and timestamps into a table may include aggregating the machine parameters according to at least one of corresponding data channel, timestamp, and machine ID. Further, the operations include receiving a request from a user for information from the table and outputting the information to the user.

In yet another aspect, the present disclosure is directed to a system for collecting and processing machine data. The system includes a first set of sensors, a second set of sensors, a user input device, a data repository, and a server. The first set of sensors is configured to detect parameters of a machine. The second set of sensors is configured to detect a location of the machine and a timestamp corresponding to the location. The user input device is configured to receive data requests from a user. The data repository is connected to the first and second sets of sensors. The server is connected to the data repository and the user input device. The server is configured to merge the parameters, locations, and timestamps into a table. During the merging process, the server may also aggregate the parameters according to at least one of corresponding data channel, timestamp, and machine ID. The server is also configured to generate information from the merged parameters, locations, and timestamps, based on the data request. The server is further configured to output the information to the user.

### BRIEF DESCRIPTION OF THE DRAWINGS

FIG. 1 is schematic diagram illustrating a system for collecting and processing data, according to an exemplary embodiment;

FIG. 2 illustrates a nested data structure, according to an exemplary embodiment.

FIG. 3 is a flow chart illustrating a method of collecting and processing data, according to an exemplary embodiment.

### DETAILED DESCRIPTION

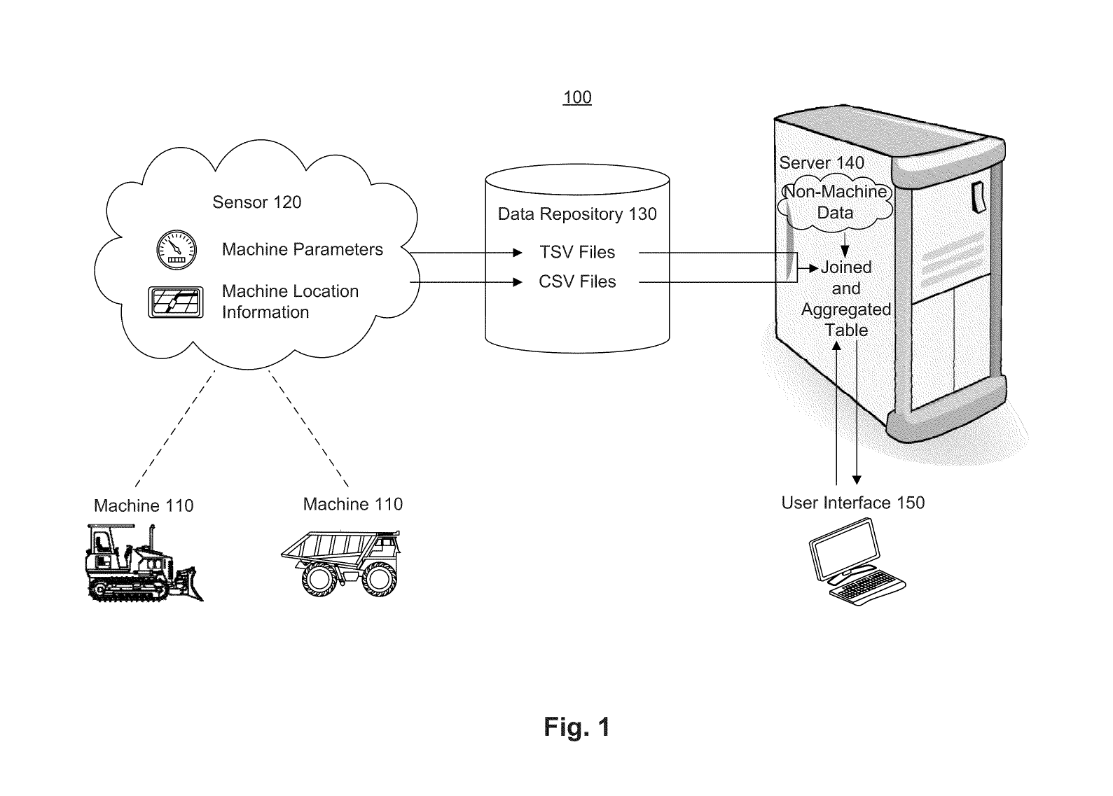

FIG. 1 illustrates an exemplary system 100 for collecting and processing data. As shown in FIG. 1, system 100 may include one or more machines 110, a plurality of on-board sensors 120, a data repository 130, a server 140, and a user interface 150.

Machine 110 may embody a fixed or mobile machine that performs some type of operation associated with an industry such as mining, construction, farming, transportation, or any other industry known in the art. For example, machine 110 may be an earth moving machine such as an excavator, a dozer, a loader, a backhoe, a motor grader, a dump truck, or any other earth moving machine. In exemplary embodiments, multiple machines 110 form a fleet and operate at remote worksites. The multiple machines 110 in the fleet may be different types of machine, as described in the above examples. It is contemplated by the disclosed embodiments that system 100 may implement any number of different types of machines.

The plurality of on-board sensors 120 may be installed on a single machine 110 or multiple machines 110. On-board sensors 120 may represent any type of device operating in a machine that detects machine data of different varieties. The machine data may include machine parameters that measure the performance of the machine. For example, the machine parameters may be engine speed, engine temperature, strut pressure, etc. The machine parameters are organized by a plurality of data channels. Each data channel corresponds to a sensor and is associated with a distinct characteristic.

The machine data may also include the machine location information and corresponding time (timestamp) when the machine parameters are taken. Such location information may enable a user to correlate machine performance with different worksite or different locations in one worksite.

In exemplary embodiments, for example, some of the plurality of on-board sensors 120 may be integrated in one or more Engine Control Modules (ECM). The ECM is configured to read values regarding the performance of an internal combustion engine. In another example, the plurality of on-board-sensors 120 may include a load weight sensor configured to detect an actual weight of material being hauled by machine 110, in the event machine 110 is configured to haul material at a worksite. In yet another example, the plurality of on-board sensors 120 may include a position device. The positioning device may be associated with a global positioning system (GPS) receiver that receives signals from GPS satellites. Based on the received signals, the positioning device may determine a real-time position, speed, velocity, or heading of machine 110.

In exemplary embodiments, the plurality of on-board sensors 120 may be part of an on-board system that includes one or more communication modules configured to facilitate data communications between the plurality of on-board sensors 120 and a data repository 130. Data repository 130 may be off board and located in a place remote from the worksite. The communication modules may include hardware and software that enable the modules to send and/or receive data messages through wireline or wireless communications. Further, data repository 130 may send and receive data to and from the plurality of sensors 120. Wireless communications may include satellite, cellular, infrared, WiFi, and any other type of wireless communication that enables the plurality of sensors 120 to wirelessly exchange information with off-board data repository 130.

In exemplary embodiments, the real-time machine location and corresponding time may be transmitted to off-board data repository 130 via an on-board gateway. The gateway includes hardware and software for leveraging a radio communication device, e.g., an antenna to transmit GPS signal to off-board data repository 130.

In exemplary embodiments, the plurality of on-board sensors 120 may collect the machine data in a predetermined frequency, such as 1 Hz. On-board sensors 120 may transmit the collected machine data to data repository 130 at the same frequency, or at a different frequency.

In exemplary embodiments, data repository 130 may be part of a vital information management system (VIMS) and PC system that collects and download vital information from a machine in a batch mode to a computer, e.g., a MINESTAR SYSTEM™ for mining operations that is used for asset management and provides an interface between a machine and a mining office; an electronic technician (ET) system for monitoring a machine for maintenance purposes; an equipment manager (EM) system for maintaining a database including data from other systems; and industrial control systems that collect data regarding engines, e.g, sensor information and indicators such as speed, revolutions per minute (RPM), etc.

Data repository 130 may include a data-receiving module, one or more processors, random access memory (RAM), read-only memory (ROM), a magnetic or optical storage device, etc. The data-receiving module receives the machine data transmitted from the plurality of on-board sensors 110. The memories and storage devices store instructions used by the processors. The processors execute the instructions to parse and save the machine data into multiple files in predetermined machine-readable formats. In one embodiment, the machine parameters may be parsed and saved in comma-separate value (CSV) files, and the machine location information and corresponding time may be parsed and saved in tab-separate value (TSV) files. Each file also contains timestamps corresponding to the machine parameters and machine locations. The parsed machine data is stored in the memories and storage devices.

In exemplary embodiments, data repository 130 parses the machine data at a pre-set frequency. For example, data repository 130 may parse the machine data once a hour, or whenever receiving new machine data. The frequencies may be chosen based on the number of sensors and reporting machines.

Server 140 may be a general purpose computer, a mainframe computer, or any combination of these components. In certain embodiments, server 140 may be standalone, or it may be part of a subsystem, which may be part of a larger system. For example, server 140 may represent distributed servers that are remotely located and communicate over a network or a dedicated network, such as a local area network (LAN) or a wide area network (WAN). In addition, consistent with the disclosed embodiments, server 140 may be implemented as a server, a server system comprising a plurality of servers, or a server farm comprising a load balancing system and a plurality of servers. Like data repository 130, server 140 may include one or more processors, one or more memories, and/or one or more storage devices. The memories and storage devices may store instructions to process machine data of different varieties.

Server 140 may be connected to data repository 130 remotely through a wired or wireless network. Server 140 may ingest the parsed machine-data files from data repository 130 continuously through a repeated process, using data transfer tools such as Apache Flume™, Application Programming Interface (API), Secure File Transfer Protocol (SFTP), etc.

Server 140 may run algorithms, e.g., Apache Hadoop™ and Hive™, to join multiple ingested machine-data files into a table. Machine data taken by different sensors, e.g., the engine speed and the machine location information, may be joined by matching one or more of the corresponding timestamp, machine ID, or fleet ID.

Server 140 may save the joined table into a predetermined data structure. In some embodiments, such predetermined data structure may be a nested data structure. For example, server 140 may execute a series of User Defined Aggregate Functions (UDAF) to aggregate multiple rows in the table into a single row. The aggregated rows are associated with the same timestamp and machine ID. In another example, Apache Avero™ and JavaScript Object Notation (JON) may be used to serialize the data in a compact binary format.

In exemplary embodiments, server 140 may also ingest non-machine data from a third-party data source. Server 140 further joins and aggregates the non-machine data with the machine data, machine location information, and corresponding time. The non-machine data is not intrinsic machine information directly collected from machine 110, but provides important contextual information regarding the operation of machine 110 and the fleet. For example, the non-machine data may include weather conditions at the worksite, commodity prices, cellular signal strength at the worksite, etc. The third-party data source may be a weather service, a commodity-exchange database, an off-board sensor, etc.

The above data joining and aggregating may be managed by a workflow scheduler system, such as Apache Oozie™. Under such workflow scheduler system, the data joining and aggregating may be automated based on data availability or at a pre-set frequency.

User interface 150 is connected to server 140 and may include an input device and a display device. The user may use the input device to input a request for certain machine data. Sever 140 receives the request and queries the joined and aggregated table based on the request, using a query language such as Apache Hive™, Structured Query Languages (SQL), etc. After server 140 returns the requested information to user interface 150, the display unit may display the requested information using visualization software, such as Tableau, Device Automation ToolKit (DATK), etc.

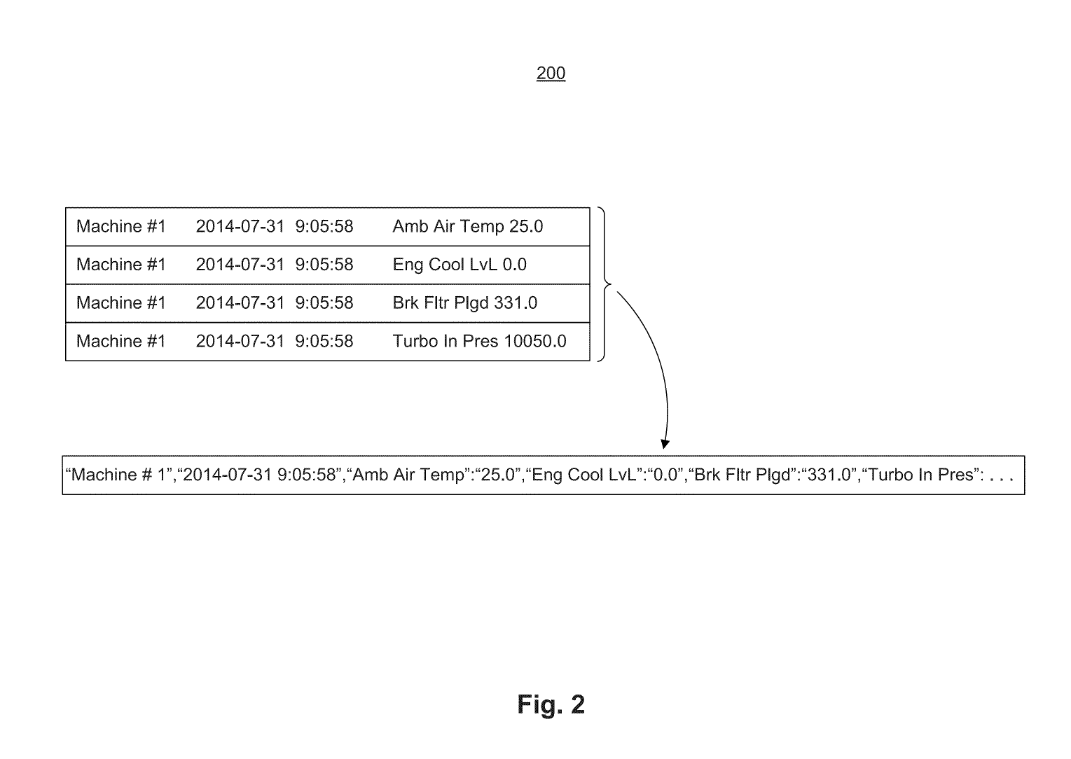

FIG. 2 illustrates an implementation of the nested data structure, according to one embodiment. In this implementation, data channels, i.e., machine parameters, associated with the same timestamp and machine ID may be aggregated into an array of maps and aggregated into a row of a table. Each row of the aggregated table may be arranged in an array of maps, and the row looks like:
{timestamp, machine ID, [map 1, map 2, map 3, . . . , map n]},
   and each map may be stored as:
<Channel Name: Channel Value, Channel Unit>.
   The number (n) of maps in an array is undefined, and may vary according to different timestamps and machine IDs. This dynamic data structure allows system 100 to handle data of different varieties. For example, although two machines may have a different number of data channels, data from both machines may be aggregated and stored in the same table.

Referring to FIG. 2, before a table is aggregated into the nested data structure, each data channel occupies a row of the table. After the aggregation, all the data channels associated with the timestamp and machine ID are put into one row. Such nested data structure may lead to space saving and easy access to data.

### INDUSTRIAL APPLICABILITY

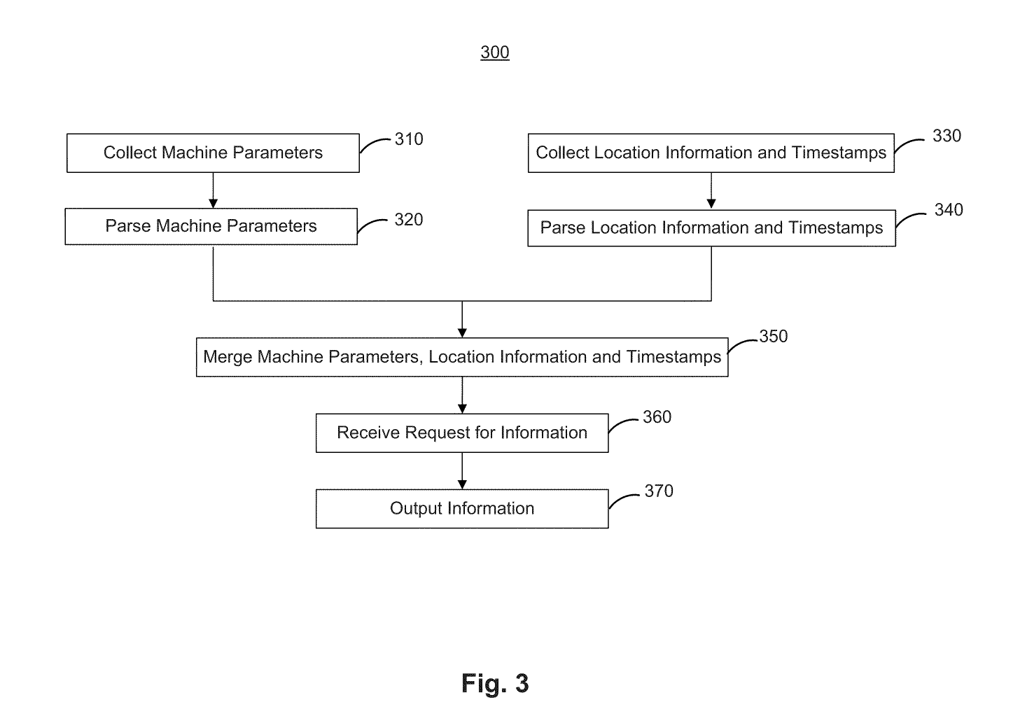

The disclosed system 100 for collecting and processing data may be applicable to any system where it is desired to combine and process machine data of different characteristics or from different types of machines. The disclosed system 100 for collecting and processing data may help to improve a user's capability to evaluate machine and fleet performance efficiently. The disclosed system 100 may be integrated into various machine or fleet monitoring systems. Accordingly, a method of collecting and processing data consistent with the implementation of system 100 will now be explained with reference to FIG. 3.

In step 310, the plurality of on-board sensors 120 collect various machine parameters. The machine parameters are organized by a plurality of data channels. Each of the plurality of data channels corresponds to a sensor and is associated with a distinct characteristic. For example, engine speed and strut pressure are two different data channels and are collected by two different sensors.

In step 320, the plurality of on-board sensors 120 may also collect location information associated with the machine and corresponding timestamps.

In step 330, the collected machine parameters are transmitted to data repository 130, where the machine parameters are parsed and saved into files in a predetermined machine-readable format, such as CSV files.

In step 340, the collected location information and corresponding timestamps are transmitted to data repository 130, where the location information and corresponding time are parsed and saved into files in another predetermined machine-readable format, such as TSV files. Each of steps 310-340 may be repeated at different frequencies. For example, steps 310 and 320 may be repeated once a second, while steps 330 and 340 may be repeated once an hour. The frequencies may be pre-set based on the system capacity and the volume of machine data to be collected and processed.

In step 350, server 140 recursively runs a workflow to load and merge the parsed machine parameters, location information, and timestamps. Server 140 may join the parsed machine parameters and location information into a table by matching one or more of the timestamp, machine ID, and fleet ID corresponding to the machine parameters and location information. Server 140 may also aggregate the joined table in a predetermined data structure. In one embodiment, the machine parameters associated with the same timestamp and the same machine ID may be aggregated into a row of the joined table to allow space saving and easy data access.

In step 360, user interface 150 receives from a user a request for information. For example, the user may request to analyze the correlations among several data channels during a specified time period and at a specified location. User interface 150 sends the request to server 140. Server 140 then queries the joined and aggregated table and generates the requested information.

In step 370, user interface 150 outputs the requested information to the user.

In exemplary embodiments, in step 350, server 140 may also merge non-machine data with the parsed machine parameters, location information, and timestamps. In steps 360 and 370, the requested information may include the non-machine data.

Several advantages over the prior art may be associated with the disclosed system 100 for collecting and processing data. First, because the same data merging method is applied to data of different varieties, the efficiency of data processing is improved. Second, system 100 is capable of handling data of different varieties and in large volumes quickly by automating data collection and processing. Third, because all the available data regarding a machine is joined and aggregated, system 100 is capable of providing data and analysis on demand. For example, users with various needs and backgrounds can customize system 100 to generate different information, such as machine performance, machine health, fleet operational costs, etc.

It will be apparent to those skilled in the art that various modifications and variations can be made to the system for collecting and processing machine data. Other embodiments will be apparent to those skilled in the art from consideration of the specification and practice of the disclosed system 100 for collecting and processing machine data. It is intended that the specification and examples be considered as exemplary only, with a true scope being indicated by the following claims and their equivalents.

What is claimed is:

1. A method of collecting and processing data, the method comprising:
receiving a first set of signals produced by a first set of sensors, the first set of signals being indicative of machine parameters, and the machine parameters being organized by a plurality of data channels with each of the plurality of data channels being associated with a distinct characteristic;
receiving a second set of signals produced by a second set of sensors, the second set of signals being indicative of location information associated with the machine and corresponding timestamps;
receiving the machine parameters, location information, and timestamps at a server;
merging the machine parameters, location information, and timestamps into a table, wherein the machine parameters are aggregated according to at least one of corresponding data channel, timestamp, and machine ID;
receiving a request from a user for information from the table; and
outputting the information to the user.

2. The method of claim 1, wherein the plurality of data channels are associated with machine parameters from a single machine.

3. The method of claim 1, wherein the plurality of data channels are associated with different machines.

4. The method of claim 1, wherein receiving of the machine parameters, location information, and timestamps is repeated at a first predetermined frequency.

5. The method of claim 1, wherein merging of the machine parameters, location information, and timestamps is repeated at a second predetermined frequency, and the machine parameters, location information, and timestamps are merged into the table during each repetition.

6. The method of claim 1, wherein receiving the first set of signals indicative of the machine parameters further comprises:
receiving the machine parameters via the plurality of data channels;
transmitting the machine parameters to a data repository;
parsing the machine parameters into a first predetermined machine-readable format; and
storing the machine parameters in a first file.

7. The method of claim 1, wherein receiving the second set of signals indicative of the location information and timestamps further comprises:
transmitting the location information and timestamps to a data repository;
parsing the location information and timestamps into a second predetermined machine-readable format; and
storing the location information and timestamps in a second file.

8. The method of claim 1, wherein merging the machine parameters, location information, and timestamps into the table further comprises:
ingesting the machine parameters into a processor;
ingesting the location information and timestamps into the processor;
matching one or more of the timestamp, machine ID, and fleet ID of the machines parameters and location information; and
storing the matched machine parameters and location information in a predetermined data structure within the table.

9. The method of claim 8, wherein storing the matched machine parameters in the predetermined data structure within the table further comprises:
aggregating the machine parameters that are associated with the same timestamp and the same machine ID into one row of the table.

10. The method of claim 9, wherein each row of the table includes the timestamp, the machine ID, and an array of maps, each map of the array of maps corresponding to one data channel of the plurality of data channels and including the machine parameters associated with the one data channel of the plurality of data channels.

11. The method of claim 1, wherein merging the machine parameters, location information, and timestamps into the table further comprises:
merging the machine parameters, location information, and timestamps with non-machine data, wherein the non-machine data is received from a third-party data source.

12. The method of claim 1, wherein outputting the information to the user comprises:
generating a query based on the request of the user;
running the query against the merged table; and
presenting a result corresponding to the query in a user interface.

13. A non-transitory computer-readable storage medium storing instructions for collecting and processing data, the instructions causing at least one processor to perform operations comprising:
receiving machine parameters organized by a plurality of data channels, each of the plurality of data channels being associated with a distinct characteristic;
receiving location information associated with the machine and corresponding timestamps;
transferring the machine parameters, location information, and timestamps to a server;
merging the machine parameters, location information, and timestamps into a table, wherein the machine parameters are aggregated according to at least one of corresponding data channel, timestamp, and machine ID;
receiving a request from a user for information from the table; and
outputting the information to the user.

14. The non-transitory computer-readable storage medium of claim 13, wherein the instructions cause the at least one processor to receive the machine parameters by:
receiving the machine parameters via the plurality of data channels;
parsing the machine parameters into a first predetermined machine-readable format; and
storing the machine parameters in a first file.

15. The non-transitory computer-readable storage medium of claim 13, wherein the instructions cause the at least one processor to receive the location information and timestamps by:
receiving the location information and timestamps;
parsing the location information and timestamps into a second predetermined machine-readable format; and
storing the location information and timestamps in a second file.

16. The non-transitory computer-readable storage medium of claim 13, wherein the instructions cause the at least one processor to merge the machine parameters, location information, and timestamps into the table by:
ingesting the machine parameters into the processor;
ingesting the location information and timestamps into the processor;
matching one or more of the timestamp, machine ID, or fleet ID of the machine parameters and location information; and
storing the matched machine parameters and location information in a predetermined data structure within the table.

17. The non-transitory computer-readable storage medium of claim 16, wherein the instructions cause the at least one processor to:
aggregate the machine parameters that are associated with the same timestamp and the same machine ID into one row of the table.

18. The non-transitory computer-readable storage medium of claim 17, wherein the instructions cause the at least one processor to:
fill each row of the table with the timestamp, the machine ID, and an array of maps, each map of the array of maps corresponding to one data channel of the plurality of data channels and including the machine parameters associated with the one data channel of the plurality of data channels.

19. A system for collecting and processing data, comprising:
a first set of sensors configured to detect parameters of a machine, the parameters being organized by a plurality of data channels with each of the plurality of data channels being associated with a distinct characteristic;
a second set of sensors configured to detect a location of the machine and a timestamp corresponding to the location;
a user input device configured to receive data requests from a user;
a data repository connected to the first and second sets of sensors; and
a server connected to the data repository and the user input device, the server being configured to:
merge the parameters, locations, and timestamps into a table, wherein the parameters are aggregated according to at least one of corresponding data channel, timestamp, and machine ID; and
output information to the user based on the data request, wherein the output information is generated from the merged parameters, locations, and timestamps.

20. The system of claim 18, wherein the server is configured to:
ingest the parameters into the server;
ingest the locations and timestamps into the server;
match one or more of the timestamp, machine ID, or fleet ID of the parameters and locations; and
store the matched parameters and locations in a predetermined data structure within the table.
